(19) United States
(12) Patent Application Publication
(10) Pub. No.: US 2010/0329387 A1
(43) Pub. Date: Dec. 30, 2010

(54) WIRELESS COMMUNICATION APPARATUS AND WIRELESS COMMUNICATION METHOD

(75) Inventor: Shin WATANABE, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/790,192

(22) Filed: May 28, 2010

(30) Foreign Application Priority Data
Jun. 26, 2009 (JP) 2009-152682

(51) Int. Cl. H04L 25/03; H04B 1/04

(52) U.S. Cl. 375/296; 455/126

(57) ABSTRACT

A wireless communication apparatus includes a transmission unit configured to convert an input signal into a transmission signal, and a correction unit configured to impart, to the input signal, characteristics opposite to group delay deviation derived from amplitude deviation of a reflective wave of the transmission signal reflected from a radio transmission filter, through which the transmission signal output from the transmission unit passes to arrive at an antenna.

### CROSS-REFERENCE TO RELATED APPLICATIONS

The present application is based upon and claims the benefit of priority from the prior Japanese Patent Application No. 2009-152682 filed on Jun. 26, 2009, with the Japanese Patent Office, the entire contents of which are incorporated herein by reference.

### FIELD

The disclosures herein relate to a wireless communication apparatus and a wireless communication method.

### BACKGROUND

In wireless communication services such as a portable phone service, a wireless communication provider may multiplex plural wireless communication systems on a common antenna to provide plural services. Also, plural wireless communication providers may use a shared antenna to provide respective services.

When a service using a new wireless communication system is to be started, the new wireless communication service may be additionally provided while an existing wireless communication service is kept in operation.

Further, some of the frequency bands set aside for respective providers may be used to implement a new wireless communication system. In such a case, an existing wireless communication system and a new wireless communication system may share a base station antenna while the existing wireless communication system and the new wireless communication system use separate wireless communication equipments. An antenna duplexer may be used for the purpose of sharing an antenna.

Frequency bands used for wireless communication are limited resources. Each communication provider provides wireless communication service by using the frequency band assigned to this communication provider. Communication rate is an important factor for the provision of wireless communication service. Communication providers strive to increase communication capacity by improving communication rate. Increasing a modulation signal rate is an effective way to improve communication rate. However, an increase in modulation signal rate ends up enlarging the frequency band of transmission signals.

A filter of an antenna duplexer is desired to have such frequency characteristics that a transmission signal within an assigned frequency band is allowed to pass while frequencies outside the frequency band are attenuated. For the purpose of effectively utilizing a frequency band used in a wireless communication system, it is preferable to broaden the bandwidth of transmission signals as much as possible within the assigned frequency band. Even with a filter that achieves attenuation in the adjacent frequency bands, however, power leaking into the adjacent channels may not be sufficiently attenuated. A guard band may be provided in such a case. In the absence of a guard band, the frequency band of transmission signals of the wireless communication system and the frequency band of the filter may be narrowed in order to avoid influence on other wireless communication systems.

When an antenna is shared by plural wireless communication systems, conventionally, a CIB-type duplexer employing a constant impedance bandpass filter (hereinafter referred to as a CIB filter) is used.

FIG. 1 is a drawing illustrating a balanced-type filter 100 that is included in a CIB filter.

The balanced-type filter 100 includes hybrid circuits (HYB) 110A and 110B having equal characteristics and bandpass filters (BPF) 120A and 120B having equal characteristics, which are connected to one another as illustrated in FIG. 1.

The hybrid circuits 110A and 110B are 90-degree hybrid circuits that produce output signals having a 90-degree phase difference.

A signal applied to the top-left input terminal of the hybrid circuit 110A is output from the two right-hand-side terminals of the hybrid circuit 110A as signals having an equal signal level with a 3-dB drop. In this configuration, the bottom-left input terminal of the hybrid circuit 110A is an isolation terminal, which is terminated with a 50-Ω characteristic impedance.

The signals output from the two right-hand-side terminals of the hybrid circuit 110A pass through the bandpass filters 120A and 120B, at which unnecessary frequency components outside the frequency band are removed, and are applied to the two left-hand-side terminals of the hybrid circuit 110B. The signals applied to the hybrid circuit 110B are combined to be output from the bottom-right output terminal of the hybrid circuit 110B. The top-right terminal of the hybrid circuit 110B is an output-side isolation terminal, which is terminated with a 50-Ω characteristic impedance.

FIG. 2 is a drawing illustrating a related-art CIB filter 200. This example is directed to a case in which 4 frequency bands f1 through f4 are combined together.

The CIB filter 200 is configured such that plural balanced-type filters as illustrated in FIG. 1 are cascade-connected one after another, with the output terminal of a given stage (e.g., BPF2 stage) being connected to the output-side isolation terminal of the next stage (e.g., BPF3 stage). The frequency bands f2 through f4 of the bandpass filters BPF2 through BPF4 of these balanced-type filters vary from wireless communication system to wireless communication system.

The input terminals of the CIB filter 200 are coupled to wireless communication apparatuses, which include a transmission and reception amplification unit. The bottom-right antenna output terminal of the CIB filter 200 is coupled to an antenna. The CIB filter 200 combines signals from the wireless communication apparatuses coupled to the respective input terminals, and outputs the combined signals through the antenna output terminal, thereby allowing the plural wireless communication apparatuses to share the antenna.

FIG. 3 is a drawing illustrating an example of the transmission characteristics 300 of the CIB filter 200 between its input terminals and antenna output terminal illustrated in FIG. 2. The horizontal axis represents frequency, and the vertical axis represents attenuation (as measures in units of dB). FIG. 4 is a drawing illustrating an enlarged view of a portion 301 of the transmission characteristics 300 illustrated in FIG. 3. The modulation scheme is orthogonal frequency division multiplexing access (i.e., OFDMA) in the case of FIG. 3 and FIG. 4.

Each of the frequency bands f1 through f4 has a bandwidth of approximately 10 MHz. For the purpose of efficiently utilizing frequency resources, these frequency bands are closely situated to one another. If the transmission frequency bands of the bandpass filters coincide with signal frequency bands, each wireless communication system may densely distribute spectrums to efficiently utilize frequency resources. In the case of the frequency band f2, for example, the bandwidth of spectrums of transmission signals are broadened as wide as the transmission frequency band of the bandpass filter, as illustrated in FIG. 4, thereby efficiently utilizing the transmission bandwidth of the bandpass filter.

An attempt to attenuate the output power of a transmission amplifier leaking into the adjacent channels to a desired level results in the filter transmission characteristics having a phase rotation around the edges of the filter transmission band. This causes an increase in group delay deviation. An increase in attenuation outside the frequency band causes an increase in group delay deviation. When a group delay deviation is added to modulation signals, a modulation symbol point is displaced, so that the modulation accuracy of wireless transmission signals will degrade.

### [Related-Art Documents]

### [Patent Document]

[Patent Document 1] Japanese Laid-open Patent Publication No. 2000-236270

### SUMMARY

According to an aspect of the embodiment, a wireless communication apparatus includes a transmission unit configured to convert an input signal into a transmission signal, and a correction unit configured to impart, to the input signal, characteristics opposite to group delay deviation derived from amplitude deviation of a reflective wave of the transmission signal reflected from a radio transmission filter, through which the transmission signal output from the transmission unit passes to arrive at an antenna.

According to another aspect of an embodiment, a wireless communication method includes converting an input signal into a transmission signal, receiving a reflective wave of the transmission signal reflected from a radio transmission filter that supplies the transmission signal to an antenna, and imparting, to the input signal, characteristics opposite to group delay deviation derived from amplitude deviation of the received reflective wave.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating a balanced-type filter that is included in a CIB filter;

FIG. 2 is a drawing illustrating a related-art CIB filter;

FIG. 3 is a drawing illustrating an example of the transmission characteristics of the CIB filter between its input terminals and antenna output terminal illustrated in FIG. 2;

FIG. 4 is a drawing illustrating an enlarged view of a portion of the frequency characteristics illustrated in FIG. 3;

FIG. 5 is a block diagram illustrating an example of a wireless communication system according to an embodiment;

FIG. 6 is a block diagram illustrating an example of the configuration of a radio transmission filter (CIB filter) illustrated in FIG. 5;

FIG. 7 is a drawing illustrating an example of the characteristics of a bandpass filter used in the CIB filter;

FIG. 8A is a drawing illustrating the characteristics of a bandpass filter having a high Q factor;

FIG. 8B is a drawing illustrating the characteristics of the bandpass filter having a high Q factor;

FIG. 8C is a drawing illustrating the characteristics of a bandpass filter having a medium Q factor;

FIG. 8D is a drawing illustrating the characteristics of the bandpass filter having a medium Q factor;

FIG. 8E is a drawing illustrating the characteristics of a bandpass filter having a low Q factor;

FIG. 8F is a drawing illustrating the characteristics of the bandpass filter having a low Q factor;

FIG. 9A is a drawing illustrating spectrums input into BPF2;

FIG. 9B is a drawing illustrating the frequency characteristics of a reflective signal;

FIG. 10 is a block diagram illustrating an example of the configuration of the wireless transmission apparatus illustrated in FIG. 5;

FIG. 11A is a drawing illustrating frequency spectrums observed at measurement point A in the wireless communication apparatus illustrated in FIG. 10;

FIG. 11B is a drawing illustrating frequency spectrums observed at measurement point B in the wireless communication apparatus illustrated in FIG. 10;

FIG. 11C is a drawing illustrating frequency spectrums observed at measurement point C in the wireless communication apparatus illustrated in FIG. 10;

FIG. 12 is a block diagram illustrating an example of a wireless communication system according to an embodiment;

FIG. 13 is a block diagram illustrating an example of a wireless communication system according to another embodiment; and

FIG. 14 is a flowchart illustrating a wireless communication method according to an embodiment.

### DESCRIPTION OF EMBODIMENTS

In the following, embodiments will be described with reference to the accompanying drawings.

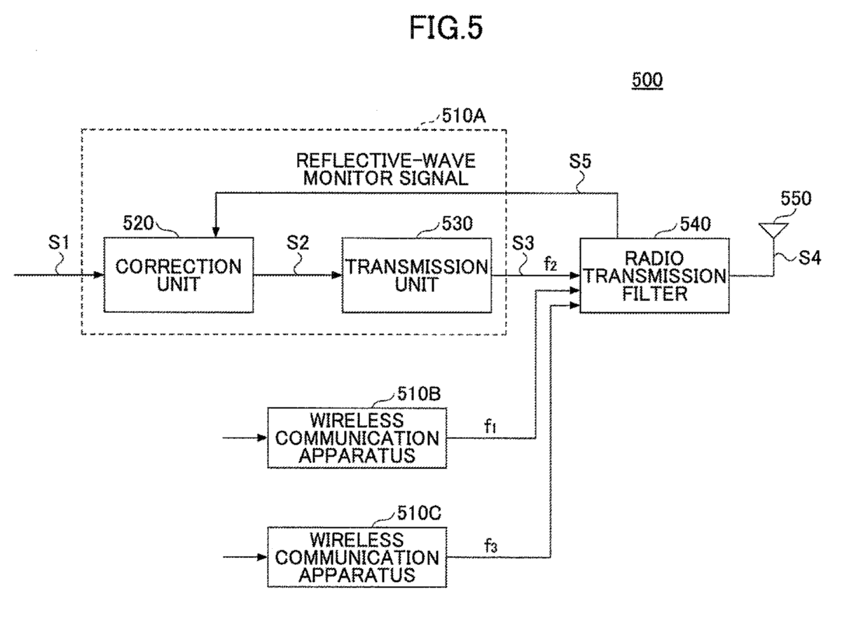

FIG. 5 is a block diagram illustrating an example of a base station 500 according to an embodiment.

The base station 500 includes a wireless communication apparatus 510A, a radio transmission filter 540, and an antenna 550. The wireless communication apparatus 510A includes a correction unit 520 and a transmission unit 530, and performs wireless communication using a frequency band f2, for example. Further, the base station 500 may include other wireless communication apparatuses 510B and 510C, which perform wireless communication using frequency bands f1 and f3, respectively, for example.

The correction unit 520 corrects the group delay distortion of an input signal S1, which may be a baseband signal, based on the slope of amplitude deviation of a reflective-wave monitor signal S5 supplied from the radio transmission filter 540, which is a CIB filter, for example. The corrected signal is output as a corrected input signal S2.

The transmission unit 530 receives the corrected input signal S2 from the correction unit 520, and converts the received signal into a transmission signal S3 for outputting.

The radio transmission filter 540 combines transmission signals supplied from the wireless communication apparatus 510A performing wireless communication using the frequency band f2, the wireless communication apparatus 510B performing wireless communication using the frequency band f1, and the wireless communication apparatus 510C performing wireless communication using the frequency band f3, thereby outputting the resulting combined signal as an output signal S4.

The antenna 550 transmits the output signal S4 supplied from the radio transmission filter 540 for wireless transmission to mobile stations (not illustrated), for example.

In the wireless communication apparatus 510A, the correction unit 520 corrects the group delay distortion of the input signal S1 based on the slope of amplitude deviation of the reflective-wave monitor signal S5 supplied from the radio transmission filter 540. As a result, after the transmission signal S3 output from the transmission unit 530 passes through the radio transmission filter 540, the group delay distortion of the output signal S4 may be suppressed, thereby reducing degradation in communication quality. The correction unit 520 may correct the input signal S1 in response to the slope of amplitude deviation of the reflective-wave monitor signal S5 supplied from the radio transmission filter 540 so as to suppress the frequency deviation of the output signal S4.

In the following, the above-described embodiment will be further described in detail.

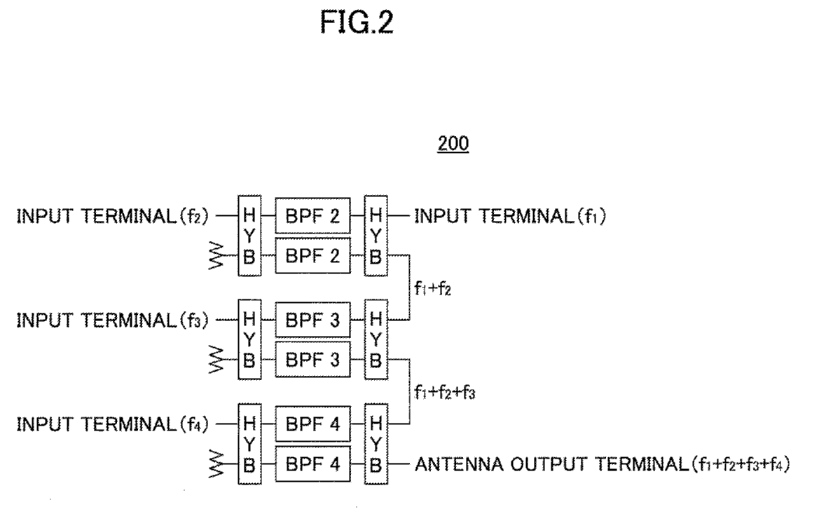

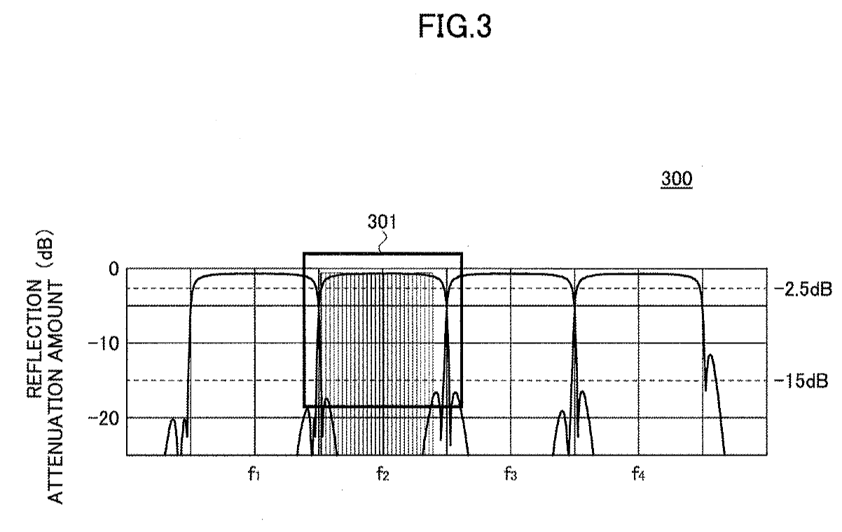

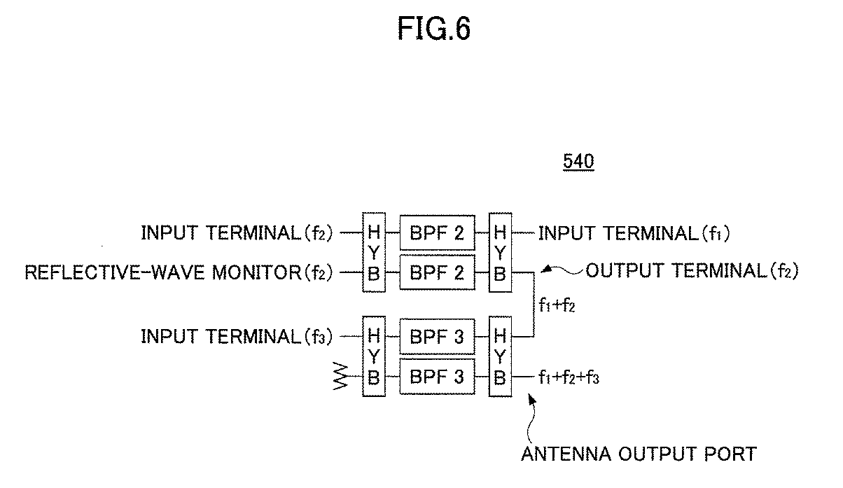

FIG. 6 is a block diagram illustrating an example of the configuration of the radio transmission filter 540 illustrated in FIG. 5. The basic configuration of the radio transmission filter 540 is similar to the configuration of the CIB filter illustrated in and described in connection with FIG. 2. There is a difference, however, in that the terminal used as the input-side isolation terminal in the related-art configuration is used as an output terminal to output the reflective-wave monitor signal, which is applied to the correction unit 520 illustrated in FIG. 5.

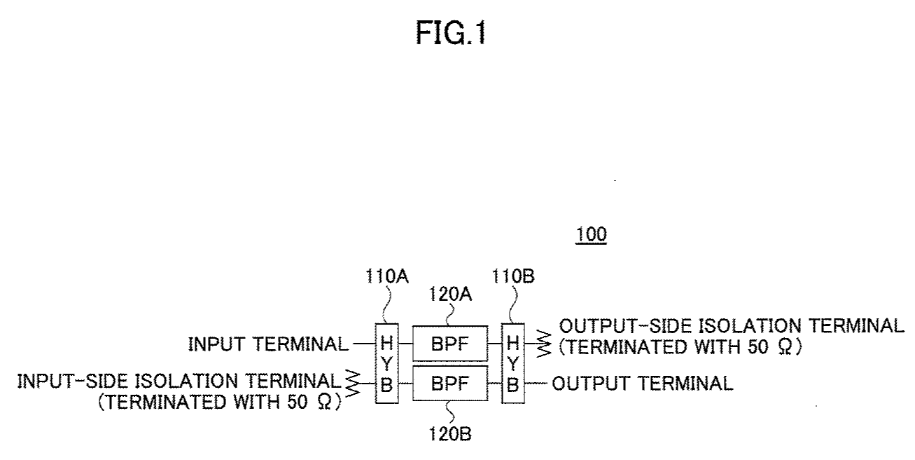

Namely, as described by referring to FIG. 1, a balanced-type filter employing a 90-degree hybrid circuit is used in such a manner that one of the left-hand-side input terminals of the hybrid circuit 110A serves as an input-side isolation terminal that is terminated.

In the present embodiment, this input terminal is used as the reflective-wave monitor terminal. In the following, the reason to use such a configuration will be described.

In order to suppress the degradation of modulation accuracy, a signal having passed through a bandpass filter may be monitored to correct distortion appearing in the transmission signal. Modulation accuracy may be measured through the direct monitoring of output characteristics of a CIB filter by providing a coupler to the output stage of the CIB filter, for example. With this arrangement, transmission signal modulation accuracy may be easily measured by directly monitoring a signal having passed through the filter.

The provision of a coupler at the output stage of a CIB filter, however, gives rise to a problem in that the loss of transmission signals increases. Also, the size of the antenna duplexer increases.

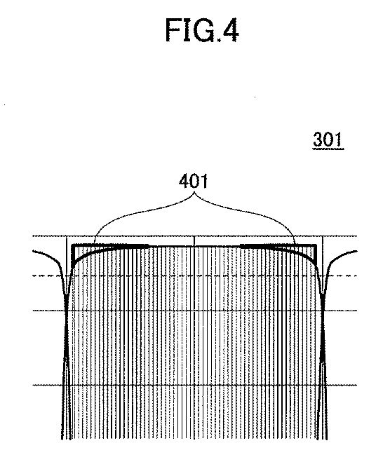

As was described in connection with FIG. 4, the transmission characteristics of a bandpass filter used in the CIB filter 540 are such that attenuation is larger toward the ends of the frequency band, compared with attenuation at the center of the frequency band (see reference numeral 401 in FIG. 4). This means that there are reflective waves traveling toward the input terminals. Namely, signals entering the bandpass filter are reflected according to the reflection coefficients. With the presence of the hybrid circuit, the reflective waves do not return to the input terminal, but are output through the reflective-wave monitor terminal (for f2).

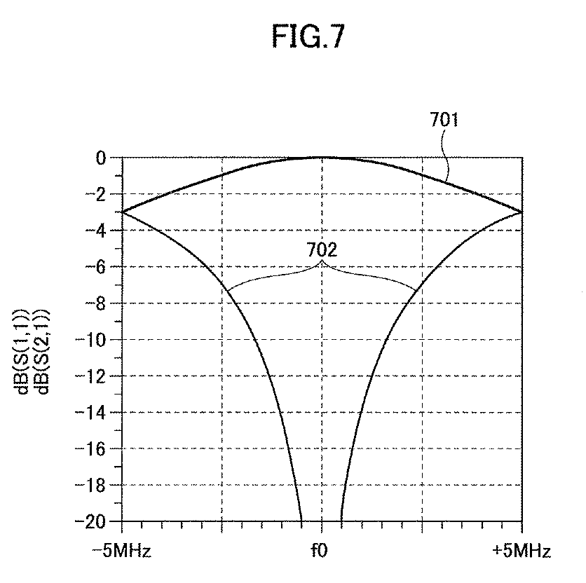

FIG. 7 is a drawing illustrating an example of the characteristics of a bandpass filter (e.g., BPF2) used in the CIB filter 540. A curve 701 represents transmission characteristics S(2, 1), and a curve 702 represents reflective characteristics S(1, 1). Here, S(2,1) and S(1,1) are S parameters.

According to the transmission characteristics S(2, 1) indicated by the curve 701, transmission loss is in the range of 0 to 3 dB within f0±5 MHz, which defines an entire frequency band.

According to the reflective characteristics S(1, 1) indicated by the curve 702, signals pass through the bandpass filter BPF2 at around the center of the frequency band without signal loss, so that the level of reflective signals is small. Namely, the reflective signals output from the reflective-wave monitor terminal (for f2) have the characteristics indicated by the curve 702, which indicate that the reflective power level is low at around the center of the frequency band (i.e., smaller than about −20 dB).

Accordingly, a signal waveform monitored at the reflective-wave monitor terminal is generally different from the signal waveform of an output signal provided to the antenna.

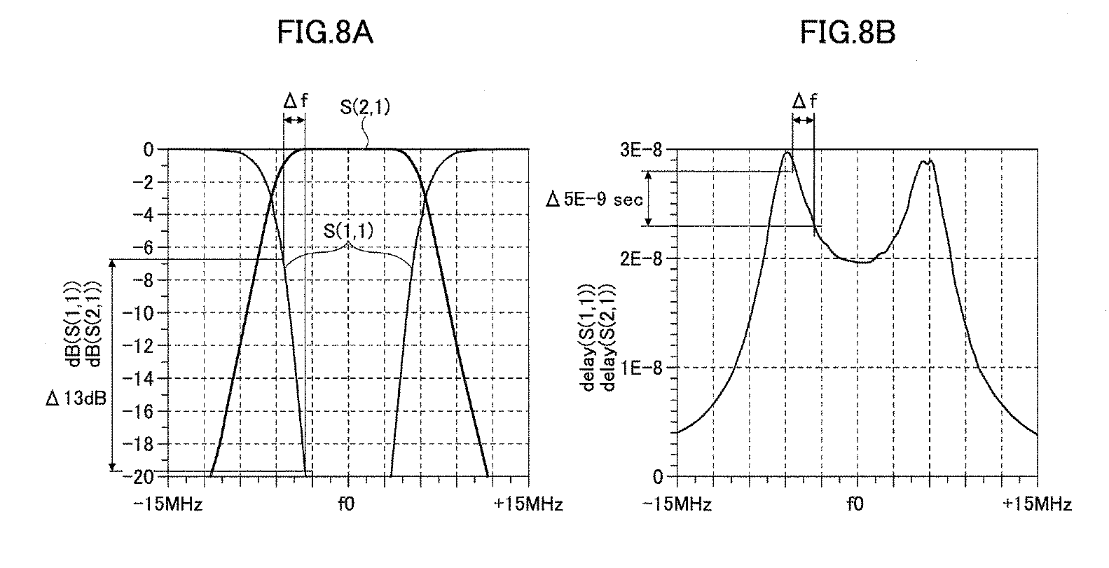

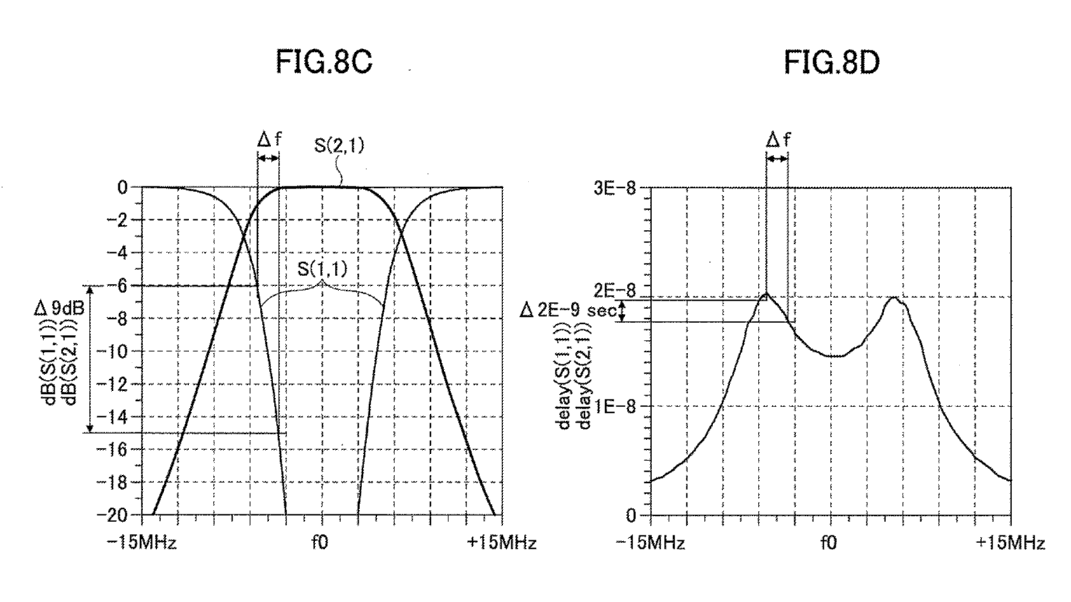

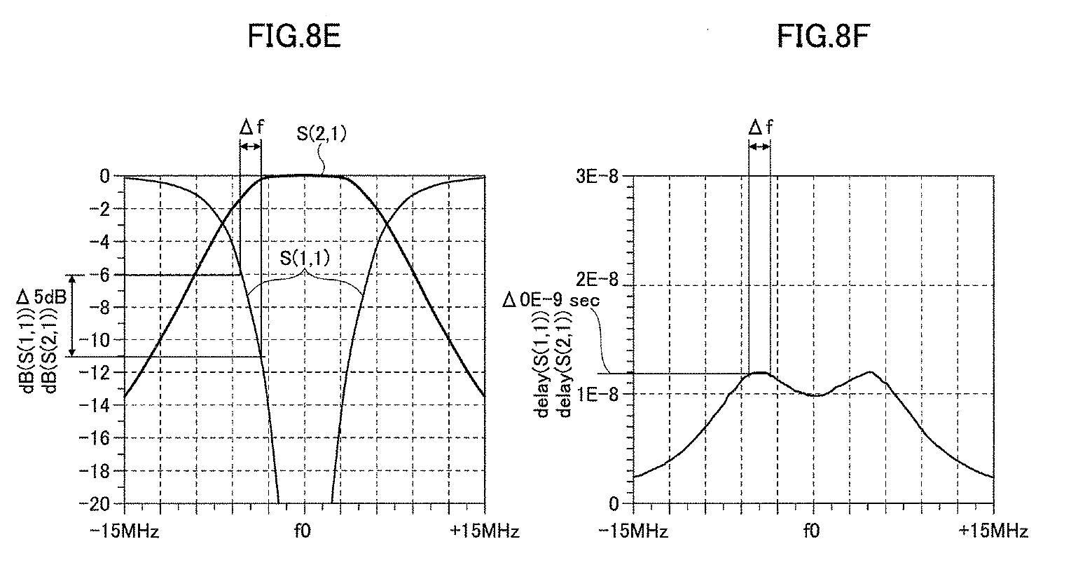

However, it is possible to estimate a group delay deviation of the bandpass filter BPF2, which causes modulation accuracy to degrade, based on the method that will be described below by referring to FIG. 8A through 8F. FIGS. 8A through 8F are drawings illustrating the characteristics of a bandpass filter.

FIGS. 8A and 8B, FIGS. 8C and 8D, and FIGS. 8E and 8F illustrate the cases of the Q factor of the bandpass filter being high, medium, and low, respectively. FIGS. 8A, 8C, and 8E are graphic charts illustrating reflective characteristics S(1, 1) and transmission characteristics S(2, 1) of the bandpass filter. FIGS. 8B, 8D, and 8F are graphic charts illustrating group delay characteristics corresponding to FIGS. 8A, 8C, and 8E, respectively. Here, S(1, 1) and S(2, 1) are S parameters.

As illustrated in FIG. 8A, the use of a filter having a high-Q-factor resonator for the purpose of providing large attenuation outside the frequency band results in the filter attenuation characteristics being steep. That is, attenuation is significantly larger at f0±15 MHz than at f0±5 MHz.

It should be noted that phase rotation is likely to occur at the ends of the frequency band. In a frequency range Δf illustrated in FIG. 8B, a group delay deviation of approximately 5E-9 second is created.

As described above, the use of a high-Q-factor filter for the purpose of increasing attenuation outside the frequency band causes a group delay deviation to increase. The group delay deviation has a great impact on modulation accuracy, which may cause degradation in the modulation accuracy of transmission signals.

As the Q factor decreases, the characteristics of the bandpass filter change to those illustrated in FIG. 8C, and to those illustrated in FIG. 8E. The transmission characteristics S(2, 1) in FIGS. 8C and 8E have gentler slopes for attenuation outside the frequency band than the slopes illustrated in FIG. 8A. Further, group delay deviations illustrated in FIG. 8D and FIG. 8F are also smaller than those illustrated in FIG. 8B.

In the frequency range Δf situated at the end of the frequency band, the slope of return loss is steep when the Q factor is high as illustrated in FIG. 8B, with a large group delay deviation. In the case of the Q factor being small as illustrated in FIG. 8F, on the other hand, the slope of return loss is gentle, with a small group delay deviation.

In this manner, the reflective-wave monitor signal output from the reflective-wave monitor terminal of a CIB filter may be monitored to measure the amplitude deviation of the bandpass filter (e.g., BPF2), i.e., to measure the slope of return loss, thereby estimating the size of a corresponding group delay deviation.

By referring to FIG. 6 again, the signal reflected by BPF2 is output to the wireless communication apparatus 510A through the reflective-wave monitor terminal (for f2) as a reflective-wave monitor signal.

The frequency f1 is used by the first wireless communication system (e.g., the wireless communication apparatus 510B illustrated in FIG. 5) to provide existing communication service. A bandwidth of 10 MHz may be assigned to this system.

The frequency f3 is used by the second wireless communication system (e.g., the wireless communication apparatus 510C illustrated in FIG. 5) to provide existing communication service. A bandwidth of 10 MHz may be assigned to this system.

The frequency f2 is used for new wireless communication service (e.g., the wireless communication apparatus 510A illustrated in FIG. 5). A bandwidth of 10 MHz may be available.

The filter characteristics of the antenna duplexer for the frequency f2 may have a 3-dB transmission bandwidth of 10 MHz.

If transmission signals have a bandwidth of 9.5 MHz, there are removed frequency ranges at the ends of the spectrum band. The removed portion in the transmission characteristics is output from the reflective-wave monitor terminal (for f2) for provision to the reflective-wave monitor input of the wireless communication apparatus 510A.

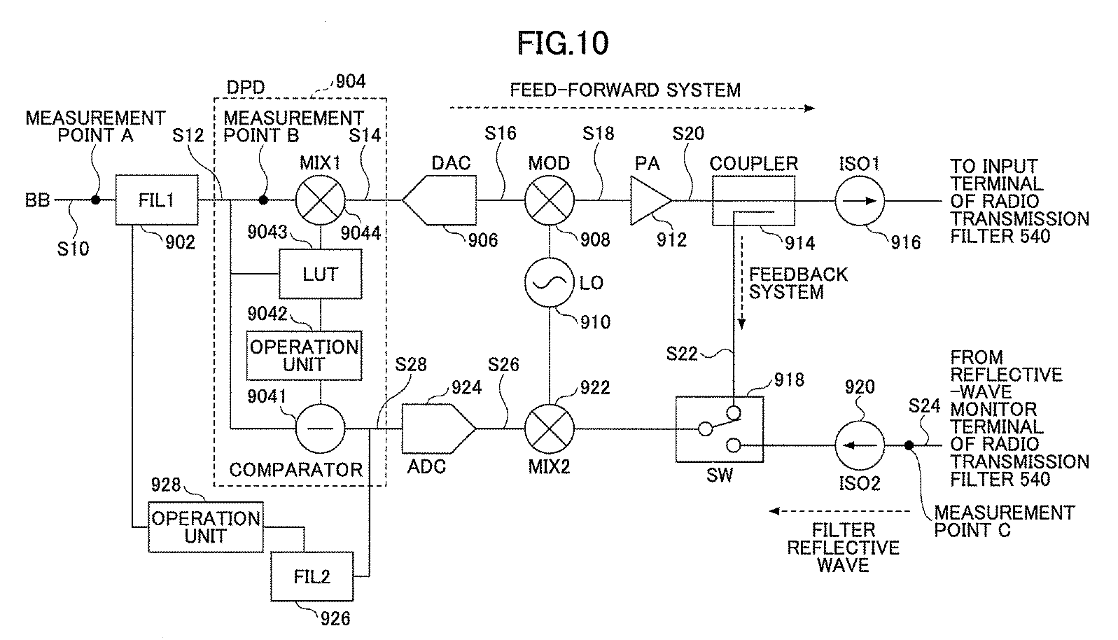

FIG. 10 is a block diagram illustrating an example of the configuration of the wireless communication apparatus 510A illustrated in FIG. 5.

In the following, each part of the wireless communication apparatus 510A will be described.

A filter (FIL1) 902 receives a baseband signal S10 that is an input signal. The filter 902 corrects the group delay deviation (and frequency deviation) of the input signal, and outputs the corrected signal as a corrected input signal S12.

A digital predistorter (DPD) 904 produces a signal S14 obtained by providing distortion to the corrected input signal S12 based on a feedback signal from a coupler 914 for the purpose of ensuring linearity in the amplification characteristics of a power amplifier 912.

A digital-to-analog converter (DAC) 906 receives the signal S14, and performs digital-to-analog conversion to output a signal S16.

A modulator (MOD) 908 receives the signal S16, and modulates, in accordance therewith, a carrier signal supplied from a local oscillator (LO) 910 to output a modulated signal S18.

The amplifier (PA) 912 amplifies the modulated signal S18 to a predetermined power to output a signal S20.

The amplified signal S20 is sent to the input terminal of the radio transmission filter 540 as a transmission signal via a coupler (i.e., directional coupler) 914 and an isolator (ISO1) 916.

The coupler 914 couples part of the signal S20 for provision to the feedback system of the wireless communication apparatus 510A as a feedback signal S22 for the digital predistorter (DPD) 904.

A switch (SW) 918 switches between this feedback signal S22 and a reflective-wave monitor signal S24 supplied from the reflective-wave monitor terminal (i.e., reflective-wave monitor terminal (f2) illustrated in FIG. 6) of the radio transmission filter 540. The switch 918 selects the feedback signal S22 to pass therethrough when the digital predistorter 904 operates. The switch 918 selects the reflective-wave monitor signal S24 to pass therethrough when group delay deviation correction is performed.

The reflective-wave monitor signal (i.e., filter reflective wave) from the reflective-wave monitor terminal of the radio transmission filter (CIB filter) 540 is supplied to the switch (SW) 918 via an isolator (ISO2) 920. The output impedance of the isolator (ISO1) 916 and the input impedance of the isolator (ISO2) 920 are preferably set equal to each other. With this arrangement, the impedance of the input terminal (f2) as viewed from the hybrid circuit (HYB) of the CIB filter 540 illustrated in FIG. 6 becomes equal to the impedance of the reflective-wave monitor terminal (f2). As a result, isolation between the input terminal (f2) and the reflective-wave monitor terminal (f2) is improved, thereby allowing the reflective wave from the bandpass filters (BPF2) to be output from the reflective-wave monitor terminal (f2) with high accuracy.

A mixer (MIX2) 922 performs down-conversion with respect to a signal passing through the switch (SW) 918 based on the carrier signal supplied from the local oscillator (LO) 910 to output a demodulated signal S26.

An analog-to-digital converter (ADC) 924 converts the demodulated signal S26 from analog to digital to output a digital signal S28. This digital signal S28 corresponds to the signal having passed through the switch (SW) 918.

In other embodiments, the signal supplied from the switch (SW) 918 may be down-converted into an intermediate frequency signal, which is then converted into a digital signal for further down-conversion into a baseband signal. This arrangement makes it possible to easily process DC components at the analog-to-digital converter (ADC) 924.

The digital predistorter (DPD) 904 receives the feedback signal S22 that is demodulated and digitized, and provides distortion to the input signal S11 for the purpose of canceling nonlinearity in the amplification characteristics of the amplifier 912. Namely, a feedback loop is created through the coupler 914, the mixer (MIX2) 922, and the analog-to-digital converter (ADC) 924.

In the digital predistorter (PDP) 904, a comparator 9041 compares the digital signal S28 supplied from the analog-to-digital converter (ADC) 924 with the corrected input signal S12 supplied from the filter (FIL1) 902.

A calculation unit 9042 calculates a signal distortion caused by the amplifier (PA) 912 based on the results of comparison performed by the comparator 9041, and then calculates an amplitude coefficient and phase coefficient for correcting the distortion.

A lookup table (LUT) 9043 stores the amplitude coefficient and phase coefficient calculated by the operation unit 9042.

A mixer (MIX1) 9044 multiplies the corrected input signal S12 supplied from the filter (FIL2) 902 by the amplitude coefficient and phase coefficient stored in the lookup table (LUT) 9043, thereby performing correction.

This feedback control for the digital predistorter (DPD) 904 is performed a predetermined number of times at the time the operation of the wireless communication apparatus 510A is started. This makes it possible to correct the input signal S12 so as to cancel nonlinearity in the amplification characteristics of the amplifier 912.

Moreover, the switch (SW) 918 may switch the paths to select the reflective-wave monitor terminal of the radio transmission filter 540. This allows the reflective-wave monitor signal from the bandpass filters (e.g., BPF2) of the CIB filter to be provided to the mixer (MIX2) 922.

This reflective signal is down-converted and digitized by the mixer (MIX2) 922 and the analog-to-digital converter (ADC) 924, respectively.

A filter (FIL2) 926 extracts a frequency range Δf (see FIGS. 8A through 8F) at the ends of the frequency band from the reflective signal that is down-converted and digitized.

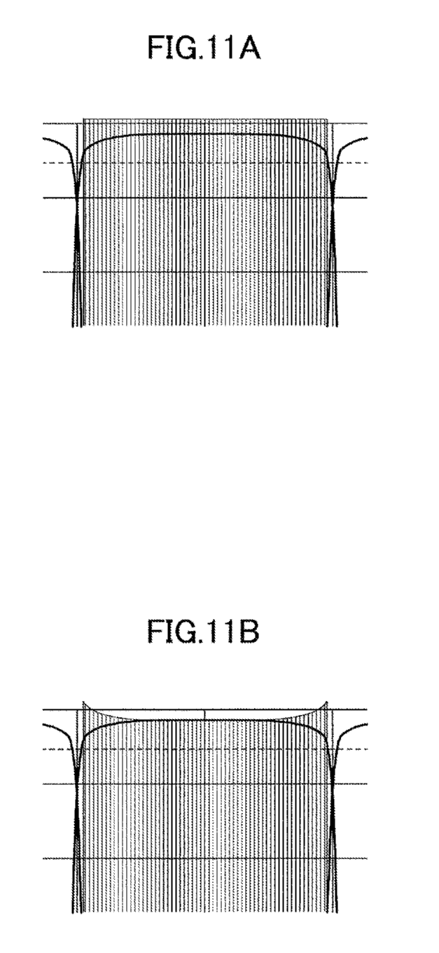

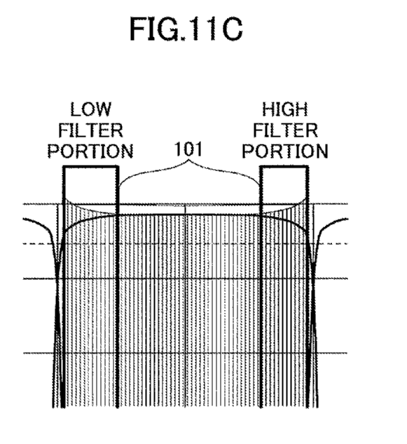

The filter (FIL2) 926 is used to extract frequency components in the low filter portion and high filter portion as illustrated in FIG. 11C.

A calculation unit 928 obtains the spectrum components of the frequency range Δf (see FIGS. 8A through 8F) by use of FFT based on the frequency ranges extracted by the filter 926.

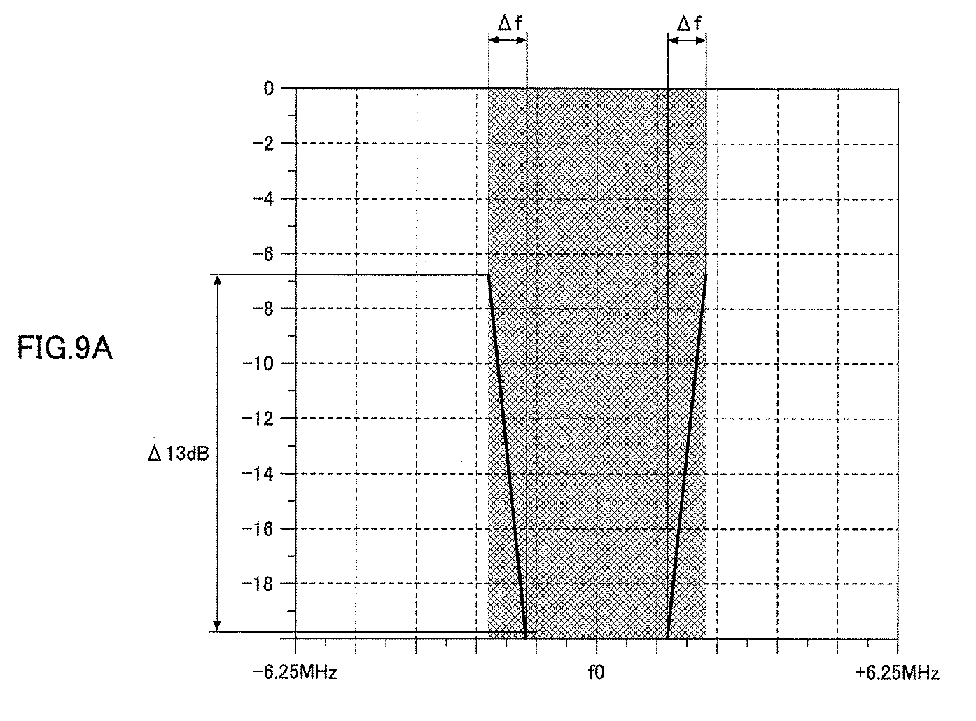

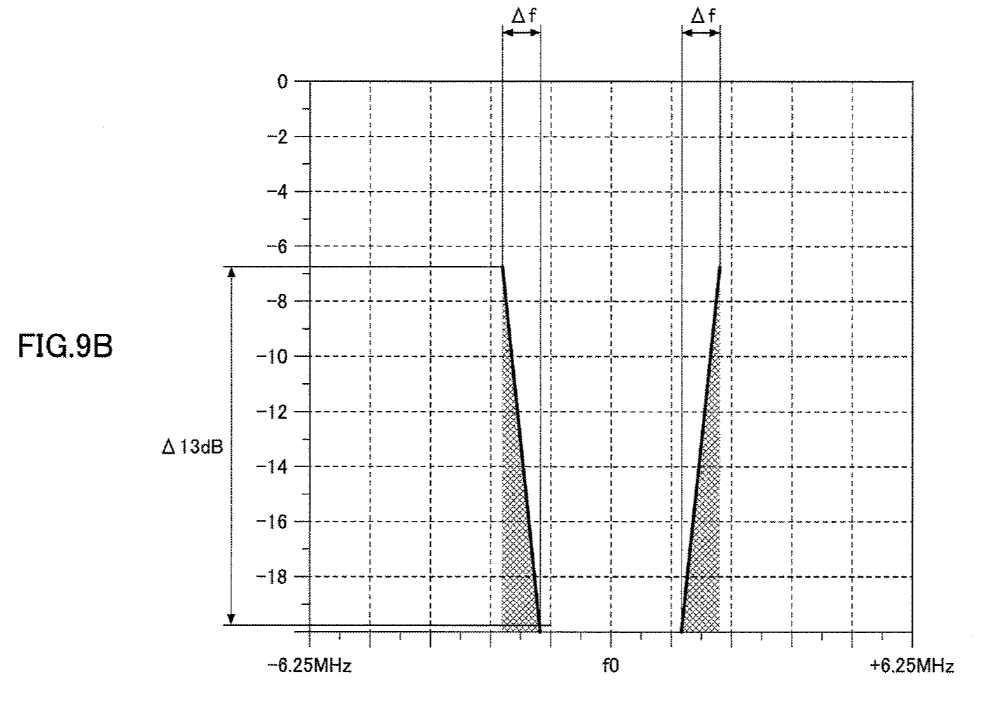

The BPF2 of the radio transmission filter (which may hereinafter be referred to as a “CIB filter) may have the reflective characteristics as illustrated in FIG. 8A, for example. In such a case, the reflective signal of the BPF2 has spectrums as illustrated in FIG. 9B when the spectrums as illustrated in FIG. 9A are input into the BPF2. With the very top of the spectrum illustrated in FIG. 9A being a reference point positioned at 0 dB, dB(S(1, 1)) illustrated in FIG. 8A represents return loss. The power equivalent to this return loss for each frequency is reflected, resulting in the spectrums illustrated in FIG. 9B.

The filter (FIL2) 926 having the frequency ranges Δf illustrated in FIG. 9B is then used to perform filtering with respect to the spectrums illustrated in FIG. 11C to extract the high filter portion and the low filter portion.

The filter (FIL2) 926 may select one of the high filter portion and the low filter portion. When the low filter portion is extracted for provision to the operation unit 928, for example, the results of FFT of the low filter portion are obtained with respect to the center frequency of the signal.

When the high filter portion is selected, the results of FFT of the high filter portion are obtained with respect to the center frequency of the signal. The operation unit 928 uses FFT to calculate the frequency components of the signal having passed through the filter (FIL2) 926. With the frequency range being selected as either the low filter portion or the high filter portion, the operation unit 928 obtains the spectrums of the low filter portion and the high filter portion illustrated in FIG. 9B, i.e., obtains the frequency characteristics of the reflective signal.

In the manner described above, the filter (FIL2) 926 and the operation unit 928 obtain the frequency characteristics of a desired frequency range by use of FFT, thereby obtaining the slopes of the signal spectrums of the frequency ranges Δf illustrated in FIG. 9B. With this arrangement, the frequency deviation of the reflective signal is identified around the edges of the frequency band of the CIB filter. Further, the group delay deviation is estimated in response to the frequency deviation of the frequency ranges Δf as was described in connection with FIGS. 8A through 8F.

The filter (FIL1) 902 corrects in advance the group delay slopes of the input signal S10 in response to the signal supplied from the operation unit 928 (i.e., in response to the amplitude deviation of the monitored frequency ranges Δf).

Plural settings may be provided in the filter (FIL1) 902. One of the settings may then be selected by the operation unit 928 in response to the amplitude deviation of the reflective-wave monitor signal of the frequency ranges Δf (see FIGS. 8A through 8F).

FIGS. 11A through 11C are drawings illustrating frequency spectrums observed at measurement points A through C in the wireless communication apparatus 510A illustrated in FIG. 10.

FIG. 11A demonstrates the spectrums of the input signal S10 observed at the measurement point A illustrated in FIG. 10. These spectrums exhibit characteristics that are flat across the entire frequency band.

FIG. 11B demonstrates the spectrums of the corrected input signal S12 observed at the measurement point B illustrated in FIG. 10. These spectrums exhibit increases at the ends of the frequency band. With this arrangement, a signal having group delay characteristics that are opposite the group delay characteristics to be introduced by the radio transmission filter (CIB filter) 540 is supplied to the circuits situated at the subsequent stages.

FIG. 11C demonstrates the spectrums of the reflective-wave monitor signal S24 supplied from the radio transmission filter (CIB filter) 540 as observed at the measurement point C illustrated in FIG. 10. This signal is not a transmissive wave but a reflective wave. The spectrums illustrated in FIG. 11C are thus similar to the spectrums of the corrected input signal S12 illustrated in FIG. 11B. Frequency band end portions 101 correspond to the ranges Δf described in connection with FIGS. 8A through 8F, and are extracted by the filter (FIL2) 926.

By referring to FIG. 10 also, the digital predistorter 904 performs distortion correction with respect to the corrected input signal S12 illustrated in FIG. 11B. This distortion correction is not continuously performed, but may be performed according to need. Distortion correction may be performed at the time of start of operation of the wireless communication apparatus or at constant intervals, for example.

The distortion-corrected signal is applied to the CIB filter 540 via the amplifier (PA) 912. The frequency band end portions are reduced according to the transmission characteristics of the bandpass filters (BPF2) (see FIG. 6) contained in the CIB filter 540, but the spectrum amount that is reduced has been added in advance by the filter (FIL1) 902. Consequently, the spectrums after passing through the filter have a group delay deviation (and amplitude deviation) equal to that of the spectrums of the input signal S10 illustrated in FIG. 11A. This makes it possible to suppress or eliminate degradation in the modulation accuracy of transmission signals for provision to the antenna.

The group delay deviation (and amplitude deviation) may fluctuate in the bandpass filters (e.g., BPF2) illustrated in FIG. 6, for example. Even in such a case, proper coefficients for the filter (FIL1) 902 are selected by monitoring the reflective signal from the bandpass filters, thereby correcting the input signal.

In the manner as described above, provision is made such that a reflective wave from the bandpass filters (e.g., BPF2) of the CIB filter is monitored, and such that the spectrums reduced by the bandpass filters are compensated for in advance based on the monitored reflective wave. This makes it possible to reduce or eliminate degradation in the modulation accuracy of transmission signals, thereby improving communication quality.

The operation unit 928 and the filter (FIL1) 902 for correcting the group delay deviation of an input signal in response to the slope of amplitude deviation of a filter reflective wave are provided in a digital circuit portion of the wireless communication apparatus 510A, so that there is no need to modify the analog circuit portion and an external filter unit. As a result, the improvement of modulation accuracy is achieved through a relatively small additional cost.

Providing a CIB filter with steep filter characteristics causes the amplitude deviation of the transmission frequency band to increase, thereby degrading insertion loss. In order to suppress degradation resulting from insertion loss, the size of the bandpass filter may typically be increased. The above-described embodiment, however, uses a digital circuit portion to properly compensate for a deviation occurring in the frequency band. Such an arrangement helps to reduce the physical size of the bandpass filter, thereby serving to miniaturize the CIB filter.

Even if the degree of reduction at the frequency band end portions of the CIB filter varies from filter to filter, optimum coefficients for the filter (FIL1) 902 are adaptively selected. A signal having the group delay deviation (and amplitude deviation) equal to that of the input signal can thus be output from the antenna.

With the above-described embodiment, there is no need to monitor the output signal of the CIB filter (e.g., at the output terminal (f2) illustrated in FIG. 6) for the purpose of suppressing the degradation of the output signal. Accordingly, degradation in wireless communication caused by the filter transmission characteristics is compensated for without excessively amplifying the transmission signal, which makes it possible to effectively utilize the frequency band.

In the embodiments described above, amplitude correction by filter characteristics has been directed to the configuration in which the wireless communication apparatus 510A uses the frequency f2. As a person having ordinary skill in the art would readily recognize, amplitude correction may equally be applicable to a configuration in which the frequency f1 or f3 is used.

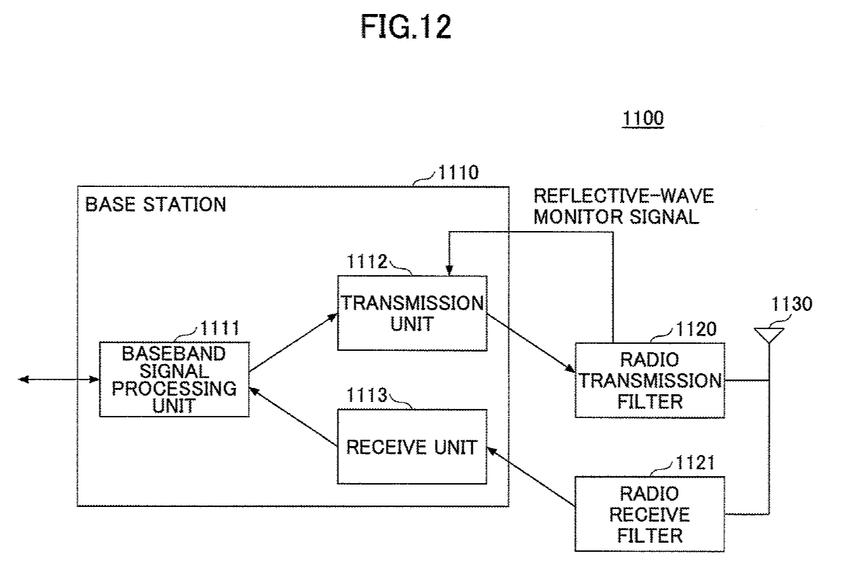

FIG. 12 is a block diagram illustrating an example of a wireless communication system 1100 according to an embodiment.

The wireless communication system 1100 includes a base station 1110, a radio transmission filter 1120 for coupling a transmission signal from the base station 1110 with another base station, and an antenna 1130 for transmitting transmission signals from the plural base stations coupled together by the radio transmission filter 1120.

The base station 1110 includes a baseband signal processing unit 1111 for processing a baseband signal.

The base station 1110 further includes a transmission unit 112 connected to the baseband signal processing unit 1111. Based on the slope of amplitude deviation of a reflective-wave monitor signal supplied from the radio transmission filter 1120, the transmission unit 112 converts the baseband signal from the baseband signal processing unit 1111 into a transmission signal, and amplifies the transmission signal. The transmission unit 112 may be the wireless communication apparatus 510A described by referring to FIG. 5, for example.

The base station 1110 further includes a receive unit 1113 for amplifying a received signal supplied from a radio receive filter 1121 connected to the antenna 130 and for converting the amplified received signal into a baseband signal.

In a case in which the transmission unit and the receive unit use a common frequency band, a single filter may be used in common in the radio transmission filter 1120 and in the radio receive filter 1121.

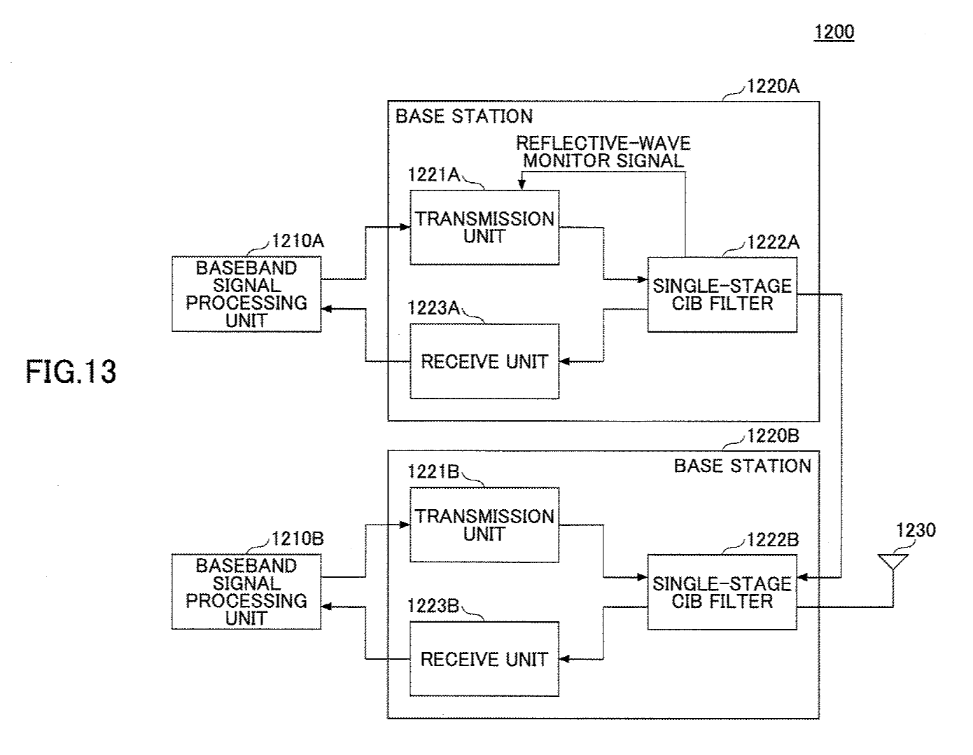

FIG. 13 is a block diagram illustrating an example of a wireless communication system 1200 according to another embodiment. FIG. 13 illustrates a configuration in which a transmission unit and a receive unit use a common frequency band, and utilize a single filter in common.

The wireless communication system 1200 includes baseband signal processing units 1210A and 1210B for processing baseband signals, base stations 1220A and 1220B, and an antenna 1230.

Each of the base stations 1220A and 1220B includes transmission units 1221A and 1221B, single-stage CIB filters 1222A and 1222B, and receive units 1223A and 1223B. Here, the term “single-stage CIB filter” refers to a unit configuration (e.g., the balanced-type filter illustrated in FIG. 1) wherein a plurality of such unit configurations are cascade-connected to form the CIB filter 540 illustrated in FIG. 6.

The transmission unit 1221A is connected to the baseband signal processing unit 1210A through an optical fiber (e.g., CPRI interface). Based on the slope of amplitude deviation of a reflective-wave monitor signal supplied from the single-stage CIB filter 1222A, the transmission unit 1221A converts the baseband signal from the baseband signal processing unit 1210A into a transmission signal, and amplifies the transmission signal. This transmission unit 1221A may be the wireless communication apparatus 510A described by referring to FIG. 5, for example.

The single-stage CIB filter 1222A is cascade-connected to the single-stage CIB filter 1222B that is contained in the base station 1220B. The single-stage CIB filters 1222A and 1222B that are cascade-connected to each other correspond to the CIB filter 540 described in connection with FIG. 6.

The base station 1220A further includes a receive unit 1223A for amplifying a received signal supplied from the single-stage CIB filter 1222A and for converting the amplified received signal into a baseband signal. The receive unit 1223A is connected to the baseband signal processing unit 1210A.

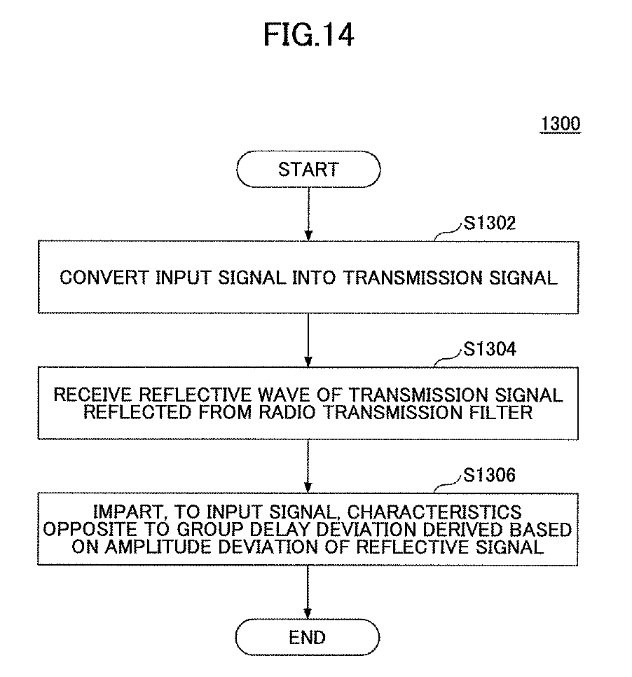

FIG. 14 is a flowchart illustrating a wireless communication method 1300 according to an embodiment.

The method 1300 may be performed by the wireless communication apparatus 510A described by referring to FIG. 5, for example.

In step S1302, a transmission unit converts an input signal into a transmission signal. The input signal may be a baseband signal. The transmission signal is sent to a radio transmission filter.

In step S1304 following step S1302, a correction unit receives a reflective wave that is the transmission signal reflected by the radio transmission filter. This reflective signal may be the signal output from the reflective-wave monitor terminal (f2) that is reflected by the BPF2 of the radio transmission filter 540 described in connection with FIG. 5 and FIG. 6, for example.

In step S1306 following step S1304, the correction unit imparts, to the input signal, characteristics opposite to group delay deviation derived from the amplitude deviation of the reflective wave. Such opposite group delay deviation characteristics are estimated based on the slope of amplitude deviation as described in connection with FIGS. 8A through 8F.

According to the embodiments described above, a wireless communication apparatus identifies the degree of a group delay deviation caused by phase rotation in filter transmission characteristics in response to the slope of spectrums of a reflective wave supplied from the radio transmission filter (e.g., CIB filter). With this arrangement, the wireless communication apparatus uses a group delay deviation correcting filter to correct a group delay occurring in the radio transmission filter to suppress degradation in modulation accuracy, thereby preventing degradation in communication quality.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A wireless communication apparatus, comprising:
a transmission unit configured to convert an input signal into a transmission signal; and
a correction unit configured to impart, to the input signal, characteristics opposite to group delay deviation derived from amplitude deviation of a reflective wave of the transmission signal reflected from a radio transmission filter, through which the transmission signal output from the transmission unit passes to arrive at an antenna.

2. The wireless communication apparatus as claimed in claim 1, wherein the correction unit includes:
a first filter configured to impart the characteristics opposite to group delay deviation to the input signal; and
a calculation unit configured to make settings to the first filter in response to the amplitude deviation of the reflective wave.

3. The wireless communication apparatus as claimed in claim 2, wherein the correction unit further includes a second filter configured to extract frequency components of a predetermined frequency range from the reflective wave.

4. The wireless communication apparatus as claimed in claim 1, further comprising:
a mixer configured to demodulate the reflective wave into a demodulated signal;
an analog-to-digital converter configured to digitize the demodulated signal into a digital signal; and
a switch configured to allow the mixer and the analog-to-digital converter to be shared by a feedback path of a digital predistorter and a path for imparting the characteristics opposite to group delay deviation to the input signal.

5. The wireless communication apparatus as claimed in claim 1, further comprising an impedance equalizing unit configured to equalize an input impedance of the reflective wave and an output impedance of the transmission signal.

6. A wireless communication method, comprising:
converting an input signal into a transmission signal;
receiving a reflective wave of the transmission signal reflected from a radio transmission filter that supplies the transmission signal to an antenna; and
imparting, to the input signal, characteristics opposite to group delay deviation derived from amplitude deviation of the received reflective wave.
